(19) United States
(12) Patent Application Publication
(10) Pub. No.: US 2003/0183380 A1
(43) Pub. Date: Oct. 2, 2003

(54) Air conditioning system using enthalpy of outside air

(76) Inventor: Dae Sung Youn, Seoul (KR)

Correspondence Address: BURNS DOANE SWECKER & MATHIS L L P, POST OFFICE BOX 1404, ALEXANDRIA, VA, 22313-1404, US

(21) Appl. No.: 10/064,960

(22) Filed: Sep. 4, 2002

(30) Foreign Application Priority Data
Mar. 26, 2002 (KR) 2002-0017556

(51) Int. Cl. F24F 3/14; F24F 6/00; F24F 11/04; F25B 29/00; G05D 23/00

(52) U.S. Cl. 165/222; 165/251; 165/291; 165/248

(57) ABSTRACT

An air conditioning system using enthalpy of the outside air controls automatically the opening rates of the outside air inflow damper and the inside air discharge damper to control automatically an amount of air flowing from the outside of a building to the inside and an amount of the air discharging from the inside to the outside depending on the difference between enthalpy of the outside air and enthalpy of an discharge air, and an amount of CO₂ detected the inside of the building. All of the control status is identified and grasped at sight by controlling all of the driving devices and setting them in a central main control system.

### CROSS REFERENCE TO RELATED APPLICATIONS

This application claims priority of Korean Patent Application No. 2002-0017556, filed Mar. 26, 2002, which is hereby incorporated by reference in its entirety.

### BACKGROUND OF INVENTION

1. Field of the Invention

The present invention relates to an air conditioning system for controlling temperature and humidity constantly, which prosecutes a control of heating, cooling and humidification, and more particularly to an air conditioning system using enthalpy of the outside air, which provides a very effective and desirable saving and management of energy by controlling automatically an amount of air flowed from the outside of a building and the inside and an amount of the air discharged from the inside of the building to the outside depending on the difference between enthalpy of outside air and enthalpy of an exhaust air being discharged from the inside of the building to the outside, and an amount of CO₂ detected the inside of the building, and, especially, controls all of the driving devices in a central main control system.

2. Description of the Related Art

Generally, an apparatus for controlling temperature and humidity constantly and an air conditioning system have been operated ineffectively in such way that, in order to maintain temperature and humidity of the inside of a building constantly during four seasons, a cooler is operated to dehumidify the inside of the building in summer, whereas a boiler and a heating and cooling humidifier are operated to humidify the inside in winter.

In order to improve these problems, there has been an control method which maintains constantly temperature and humidity of the inside of the building depending on temperature and humidity set by comparing temperature and humidity of the inside and temperature and humidity preset by operator.

Such method has effects in that energy is saved to some extent in comparison with the prior art by rendering the operator to preset the predetermined value and control it. However, there have been still remained problems that the operator has to set always manually temperature and humidity and the set temperature and humidity are incorrect.

Further, there has been a problem that the operator has to go to the place in which an heater, a cooler and a humidifier are installed in order to set temperature and humidity, since a setting section, such as a temperature setting switch and a humidity setting switch, is mounted on the above devices, respectively.

### SUMMARY OF INVENTION

Therefore, the present invention has been made in view of the above problems, and it is an object of the present invention to provide an air conditioning system using enthalpy of the outside air, which provides a very effective and desirable saving and management of energy by controlling automatically the opening rates of the outside air inflow damper and the inside air discharge damper which are installed in a building to control automatically an amount of air flowed from the outside of a building and the inside and an amount of the air discharged from the inside of the building to the outside depending on the difference between enthalpy of outside air and enthalpy of an discharging air being discharged from the inside of the building to the outside, and an amount of CO₂ detected the inside of the building.

Further, the another object of the present invention is to provide an air conditioning system using enthalpy of the outside air so that all of the control status is identified and grasped at sight by controlling all of the driving devices and setting them in a central main control system.

In accordance with the present invention, the above and other objects can be accomplished by the provision of an air conditioning system using enthalpy of the outside air, the air conditioning system comprising: a sensing section including an interior temperature sensing part detecting temperature of the inside of a building by an interior temperature sensor, the outside air temperature sensing part detecting temperature of an air which flows from an outside of the building to the inside by the outside air temperature sensor, an exhaust air temperature sensing part detecting temperature of an air which discharges from the inside of the building to outside by an exhaust air temperature sensor, a humidity sensing part detecting a humidity of the inside and outside of the building by a humidity sensor and an outside temperature humidity sensor, a fan RPM sensing part detecting RPM of an interior ventilation fan, and a CO₂ sensing part detecting a concentration of CO₂ of the inside of the building using a CO₂ sensor; a control section receiving an input sense signal from the sensing section, computing enthalpy of the air which flows from the outside of the building to the inside, and detecting the air which discharges from the inside of the building to the outside, thereby, when the difference between the enthalpies is large, decreasing largely an opening rate of the outside air inflow damper or a discharge damper so that a little amount of an air flows into the inside of the building, or a little amount of an air discharges to the outside of the building; a setting section including a temperature setting part setting the interior temperature of the building and a humidity setting part setting the exterior temperature of the building, the setting section inputting the set key value to the control section; an interior ventilation fan driving section operating the interior ventilation fan according to the control of the control section; the outside air inflow damper driving section operating the outside air inflow damper according to the control of the control section; a discharge damper driving section operating the inside air discharge damper according to the control of the control section; a heater driving section operating a heater; a cooler driving section operating a cooler; and a humidifier driving section operating a humidifier.

### BRIEF DESCRIPTION OF DRAWINGS

The above and other objects, features and other advantages of the present invention will be more clearly understood from the following detailed description taken in conjunction with the accompanying drawings, in which:

FIG. 1 is a plan view of a building provided with an air conditioning system according to an embodiment of the present invention.

FIG. 2 is a circuit diagram of the air conditioning system according to the present invention.

FIGS. 3A and 3B are flow charts of an air conditioning system using enthalpy of the outside according to the invention.

### DETAILED DESCRIPTION

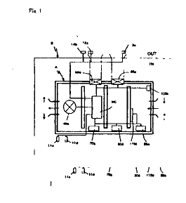

FIG. 1 is a plan view of a building provided with an air conditioning system according to an embodiment of the present invention. As shown, an air conditioning system (A) is installed in an interior section (IN) of a building (B). Temperature sensor (11a) and humidity sensor (14a) are installed in each floor and room in the interior section (IN) of the building. The air conditioning system (A) is provided with an interior ventilation fan (40c) circulating the inside air of the building.

Further, the air conditioning system (A) is provided with a heating device (70a) prosecuting the function of heating, a cooling device (80a) prosecuting the function of cooling, a humidifying device (90a) humidifying the inside of the building by generating a steam, an odor emitting device (100a) emitting an odor into the inside of the building, and a heater (110a) preventing the pipe from being frozen to burst.

An outside air inflow damper (60a) flowing an air of the exterior section (OUT) of the building into the air conditioning system (A) and an inside air discharge damper (60a) discharges an air of the air conditioning system (A) into the outside of the building are installed in one side of the air conditioning system (A). The outside air temperature sensor (12a) is installed in one side of the outside air discharge damper (60a). An exhaust air temperature sensor (13a) detecting the temperature of the inside air being discharged and the outside air humidity sensor (14b) are installed in one side of the inside air discharge damper (60a).

Further, all of the sensors and driving devices are connected to the main control system (MC) of the air conditioning system (A) so that the air conditioning system (A) is controlled and managed in the central.

The present invention having the aforementioned construction, upon the control of temperature and humidity of the inside of the building, computes enthalpy of the air which flows from the outside of the building to the inside, and detects the air which discharges from the inside of the building to the outside, thereby, when the difference between the enthalpies is large, that is, when temperature of the air flowing into the inside of the building is high, and temperature of an air discharging into the outside is low (on cooling in summer), or when temperature of the air flowing into the inside of the building is low, and temperature of an air discharging into the outside is high (on heating in winter), decreases largely an opening rate of the outside air inflow damper (50a) or the discharge damper (60a) so that a little amount of an air flows into the inside of the building.

Further, according to the present invention, an amount of CO₂ of the inside of the building is detected using CO₂ sensor not shown, and the opening rate of the outside air inflow damper (50a) or the discharge damper (60a) is automatically controlled according to the detected amount of the CO₂. That is, if the amount of CO₂ is larger, the opening rate is higher, whereas if the amount of CO₂ is smaller, the opening rate is lower.

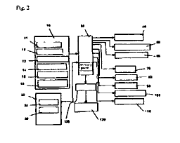

FIG. 2 is a circuit diagram of the air conditioning system according to the present invention.

As shown, reference number 10 indicates a sensing section. The sensing section (10) comprises an interior temperature sensing part (11) detecting temperature of the inside of a building by an interior temperature sensor (11a), the outside air temperature sensing part (12) detecting temperature of an air which flows from an outside of the building to the inside by the outside air temperature sensor (12a), an exhaust air temperature sensing part (13) detecting temperature of an air which discharges from the inside of the building to outside by an exhaust air temperature sensor (13a), a humidity sensing part (14) detecting a humidity of the inside and outside of the building by a humidity sensor (14a) and an outside temperature humidity sensor (14b), a fan RPM sensing part (15) detecting RPM of an interior ventilation fan (40a), and a CO₂ sensing part (16) detecting a concentration of CO₂ of the inside of the building using CO₂ sensor not shown. The sensing part (10) inputs the detected sensing signals into the control section (20).

The control section (20) stores the programmed control method of the present invention into a built-in memory part, and controls the driving part corresponding to the input of the sensing part (10).

A reference number 30 indicates a setting section. The setting section (30) includes temperature setting part (31) setting the interior temperature of the building and a humidity setting part (32) setting the exterior temperature of the building, and inputs the set key value into the control section (20).

Further, the setting section is provided with an heart driving choice key not shown for preventing the pipe from being froze to burst, and an odor emitting device driving a choice key not shown for generating the odor in the inside of the building.

A reference number 40 indicates an interior ventilation fan driving section operating the interior ventilation fan (40a) according to the control of the control section (20).

A reference number 50 indicates the outside air inflow damper driving section operating the outside air inflow damper (50a) according to the control of the control section (20).

A reference number 60 indicates a discharge damper driving section operating the inside air discharge damper (60a) according to the control of the control section (20).

Further, a reference number 70 indicates a heater driving section operating a heater (70a), a reference number 80 indicates a cooler driving section operating a cooler (80a), and a reference number 90 indicates a humidifier driving section operating a humidifier (90a).

Further, a reference number 100 indicates a heater driving section operating a heater (110a) for preventing the pipe from being frozen to burst, and a reference number 110 indicates an odor emitting driving section operating the odor emitting device (100a) for generating the odor in the inside of the building.

A reference number 120 indicates an interface. The interface (120) interfaces the control section (20) and a computer system (130), and then identifies and computes the variable data, such as a computation value of enthalpy, an integration amount, the value of computing the changing amount of enthalpy into average airflow amount and a full driving period, through the computer system (130) using the stored data in the control section (20).

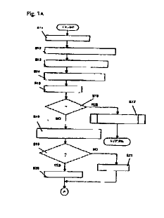

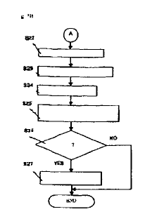

Referring to FIGS. 3A and 3B, the operation of the present invention will be described hereinafter.

Firstly, the inside air temperature sensing part (11) and the outside air humidity sensing part (14) inputs the outside temperature and humidity sensed by the outside air temperature sensor (12a) and the outside air humidity sensor (14b) into the control section (20) (step S11).

The control section (20) identifies the set value of temperature and humidity in the inside which are input by the temperature and humidity setting parts (31, 32), while receiving the input values of temperature and humidity of the outside air (step S12).

The set values of temperature (T1) and humidity (H1) are changed according to the condition of the outside air, such as temperature and humidity. This means that the condition of the inside is reset to close the condition of the outside air without departing from a scope of the allowed value of temperature and humidity of the inside (step S13). The reset data of temperature and humidity of the inside according the condition of the outside air is stored as the predetermined experimentation data in the memory part of the control section (20).

The control section (20) operates the interior ventilation fan driving part (40), the heater driving part (70), the cooler driving part (80) and the humidifier driving part (9) to drive the interior ventilation fan (40a), the heater (70a), the cooler (80a) and the humidifier (90a) according to the reset values of the temperature (T1) and humidity (H1) (step S14). For example, if the inside temperature is lower than the reset temperature, the heater (70a) is driven, whereas if the inside temperature is higher than the reset temperature, the cooler (80a) is driven.

Upon prosecuting the control for maintaining the temperature and humidity constantly, the enthalpy depending on driving of each device is detected (step S15). If the detection of the enthalpy is used for identification to the energy management and after service (step S16), the detected enthalpy value is transmitted to the computer system (130) through the interface (120). The operator, then, inspects the detected enthalpy value, writes the variation value of the enthalpy before and after driving of each device per time, and, accordingly, obtains the data of computing an average airflow and the driving period (step S17).

Meanwhile, the control device of the present invention detects the enthalpy (E1) of the air flowing from the outside to the inside by the temperature and humidity sensors (12a, 14b) provided to the outside air inlet and the enthalpy (E2) of the air discharging from the inside to the outside through the exhaust air sensor (13a) and the humidity sensor (14a) (step S18). In this step, the control device compares the enthalpy (E1) and for outside air inlet and the enthalpy (E2) for the exhaust air, and computes the difference between the enthalpies, and, then, adjusts automatically the opening rate of the outside air inflow damper (50a) and the discharge damper (60a) according to the difference between the enthalpies (step S19). That is, if the difference is la rge, the control device lowers the opening rate of the outside air inflow damper (50a) and the discharge damper (60a). Thus, the heat efficiency is made higher (step S20). On the contrary, if the difference is small, the control device raises the opening rate of the outside air inflow damper (50a) and the discharge damper (60a). Thus, it causes the inside and outside air to be flowed in a large amount (step S21).

The set value of the opening rate according to the difference between the enthalpies (E1 E2) is already stored as a predetermined experiment value in the memory part.

Further, the control section (20) detects RPM of the interior ventilation fan (40a) through the fan driving RPM sensing part (15) (step S22), and controls constantly the speed of the fan, thereby raising the heat efficiency (step S23).

Further, the control section (20) detects temperature of the inside of the building (step S24), and, when the detected temperature is lower than the predetermined value (the temperature on being frozen to burst), drives the heater (110a) to prevent the pipe from being frozen to burst (step S25).

Further, the control section (20) determines whether it drives the odor emitting device (100a) or not by the input value from the setting section (30) (step S26), and, when the driving of the odor emitting device (100a) is determined, drives the odor emitting device (100a) (step S27).

Accordingly, an air conditioning system according to the present invention provides a very effective saving and management of energy by controlling automatically an amount of air flowed from the outside of a building and the inside and an amount of the air discharged from the inside of the building to the outside depending on the difference between enthalpy of outside air and enthalpy of an discharging air being discharged from the inside of the building to the outside.

Further, all of the control and management of the air conditioning system are prosecuted in the central main control system. Thus, an operator need not go to the place in which a driving device is installed whenever setting it.

Further, according to the present invention, if the concentration of CO₂ of the inside of the building is detected, the inflow of the outside air is controlled to prevent the air of the inside from pollution.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An air conditioning system using enthalpy of the outside air, said air conditioning system comprising:
a sensing section including an interior temperature sensing part detecting temperature of the inside of a building by an interior temperature sensor, the outside air temperature sensing part detecting temperature of an air which flows from an outside of the building to the inside by the outside air temperature sensor, an exhaust air temperature sensing part detecting temperature of an air which discharges from the inside of the building to outside by an exhaust air temperature sensor, a humidity sensing part detecting a humidity of the inside and outside of the building by a humidity sensor and an outside temperature humidity sensor, a fan RPM sensing part detecting RPM of an interior ventilation fan, and a CO₂ sensing part detecting a concentration of CO₂ of the inside of the building using CO₂ sensor;
a control section receiving an input sense signal from said sensor section, computing enthalpy of the air which flows from the outside of the building to the inside, and detecting the air which discharges from the inside of the building to the outside, thereby, when the difference between the enthalpies is large, decreasing largely an opening rate of the outside air inflow damper or a discharge damper so that a little amount of an air flows into the inside of the building, or a little amount of an air discharges to the outside of the building; a setting section including temperature setting part setting the interior temperature of the building and a humidity setting part setting the exterior temperature of the building, the setting section inputting the set key value to the control section;
an interior ventilation fan driving section operating the interior ventilation fan according to the control of the control section;
an outside air inflow damper driving section operating the outside air inflow damper according to the control of the control section;
a discharge damper driving section operating the inside air discharge damper according to the control of the control section;
a heater driving section operating a heater;
a cooler driving section operating a cooler; and
a humidifier driving section operating a humidifier.

2. The air conditioning system according to claim 1, wherein said setting section further comprises an heart driving choice key for preventing the pipe from being froze to burst.

3. The air conditioning system according to claim 1, wherein said setting section further comprises an odor emitting device driving choice key for generating the odor in the inside of the building.

4. The air conditioning system according to claim 1, wherein said air conditioning system further comprises a heater driving section operating an heater for preventing the pipe from being frozen to burst.

5. The air conditioning system according to claim 1, wherein said air conditioning system further comprises an odor emitting driving section operating the odor emitting device for generating the odor in the inside of the building.

6. The air conditioning system according to claim 1, wherein all of the sensors and driving devices are connected to the main control system so that said air conditioning system is controlled and managed in the central.

7. The air conditioning system according to claim 1, wherein said control section detects an amount of CO₂ of the inside of the building, and adjusts automatically an amount of the air which flows to the inside and an amount of the air which discharges to the outside according to the detected amount.
